(19) United States
(12) Patent Application Publication
(10) Pub. No.: US 2015/0214714 A1
(43) Pub. Date: Jul. 30, 2015

(54) Pre-bracing tube of a cold shrinking sleeve

(71) Applicant: CHARDON TAIWAN CORPORATION, MIAO LI HSIEN (TW)

(72) Inventor: Thomas LIANG, MIAO LI HSIEN (TW)

(73) Assignee: CHARDON TAIWAN CORPORATION, MIAO LI HSIEN (TW)

(21) Appl. No.: 14/167,494

(22) Filed: Jan. 29, 2014

(51) Int. Cl. H02G 15/18

(52) U.S. Cl. CPC H02G 15/1833

(57) ABSTRACT

A pre-bracing tube of a cold shrinking sleeve includes a tubular body made integrally of plastic. The tubular body has its outer circumferential wall forming a spiral and successive tearing groove and a spiral and successive belt body between every two tearing grooves when the tubular body is shaped. Thus, when the tubular body is torn along the tearing grooves, the belt bodies can be drawn and takes advantage of an opportunity to draw the torn portion out of the tubular body. The tearing groove of the tubular body is formed when the tubular body is injection molded so it is needless to carry out any processing to the tubular body for obtaining a finished product, easy in manufacturing, convenient in production and able to lower cost. In addition, various molds can be made for matching with requirements of different diameters or lengths.

### BACKGROUND OF THE INVENTION

1. Field of the Invention

This invention relates to a pre-bracing tube, particularly to one for a cold shrinking sleeve.

2. Description of the Prior Art

A conventional cable bifurcation joint 1, as shown in FIG. 1, is provided with a main cable 2 carrying out bifurcation connection when a cable circuit needs to be bifurcated and connected.

Referring to FIG. 2, when the cable bifurcation joint 1 of the main cable 2 is constructed, the cable bifurcation connection portion needs to be wound and wrapped up layer by layer with PVC tape 3 for waterproofing so as to attain wrapping and protecting effects.

However, the construction procedure of the conventional cable bifurcation joint is complicated and the wrapping process is carried out through manual operation; therefore, it is hard to control quality stability of winding and wrapping work. In view of foresaid drawback, the inventor of this invention thinks that execution of work of wrappage and protection structure of the conventional cable bifurcation joint is necessary to be ameliorated.

### SUMMARY OF THE INVENTION

The objective of this invention is to offer a pre-bracing tube of a cold shrinking sleeve, able to simplify execution of protecting a cable bifurcation joint, easy in manufacturing and able to lower cost.

The pre-bracing tube of a cold shrinking sleeve in the present invention includes a tubular body made integrally of plastic. The tubular body has its outer circumferential wall forming many tearing grooves that are spirally and continuously arranged around the outer circumferential wall of the tubular body and having a spiral and successive belt bodies formed between every two tearing groove when the tubular body is shaped. When the tubular body is torn along the tearing groove, the belt body can be drawn and takes advantage of an opportunity to have the torn portion pulled out of the tubular body.

The tearing groove of the tubular body of the pre-bracing tube in the present invention is formed when the tubular body is injection molded; therefore, it is unnecessary to carry out any processing to the tubular body, convenient in production, easy in manufacturing, able to lower cost and acquiring economical gains. In addition, various molds can be made in this invention according to requirements for producing suitable pre-bracing tubes of different diameters or lengths.

### BRIEF DESCRIPTION OF DRAWINGS

This invention will be better understood by referring to the accompanying drawings, wherein:

FIG. 1 is a schematic view of a conventional cable bifurcation joint;

FIG. 2 is a schematic view of the conventional cable bifurcation joint wrapped up with PVC tape;

FIG. 3 is an outside view of the pre-bracing tube of a cold shrinking sleeve in the present invention;

FIG. 4 is a partial cross-sectional view of the pre-bracing tube of a cold shrinking sleeve in the present invention;

FIG. 5 is a schematic view of the pre-bracing tube of a cold shrinking sleeve in the present invention; illustrating that the pre-bracing tube is fitted in the cold shrinking sleeve;

FIG. 6 is a schematic view showing a state of the pre-bracing tube drawn out in the present invention;

FIG. 7 is a schematic view showing a process of drawing out the pre-bracing tube in the present invention; and

FIG. 8 is a schematic view showing a state that the pre-bracing tube is removed from the cold shrinking sleeve in the present invention;

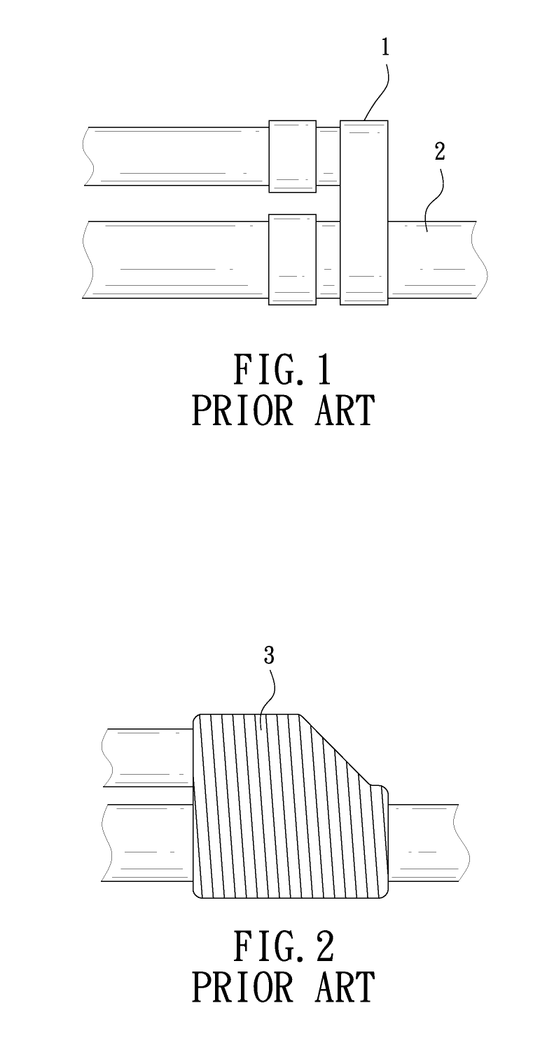

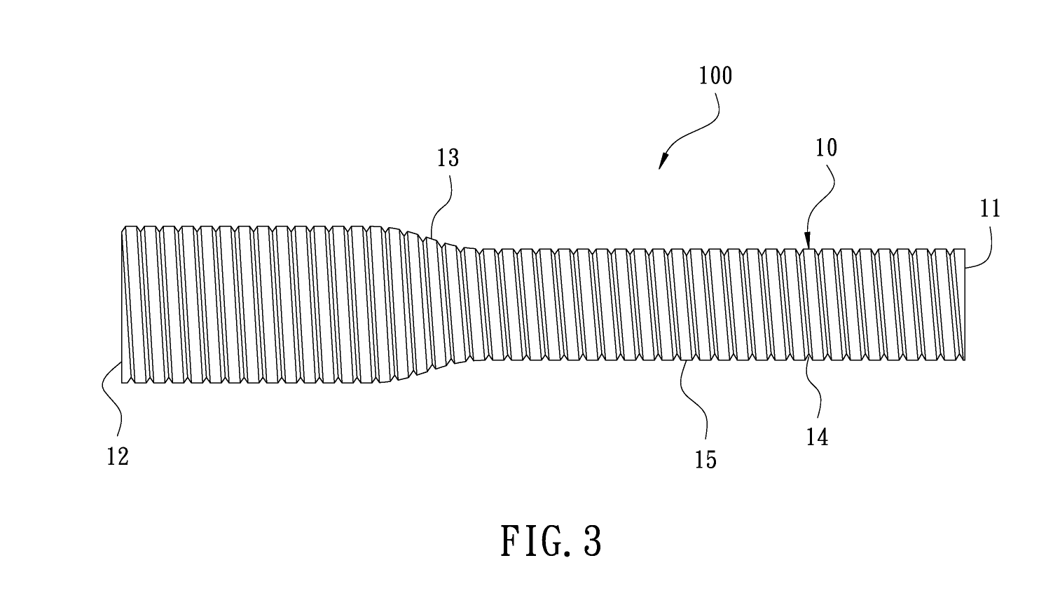

### DETAILED DESCRIPTION OF THE PREFERRED EMBODIMENT

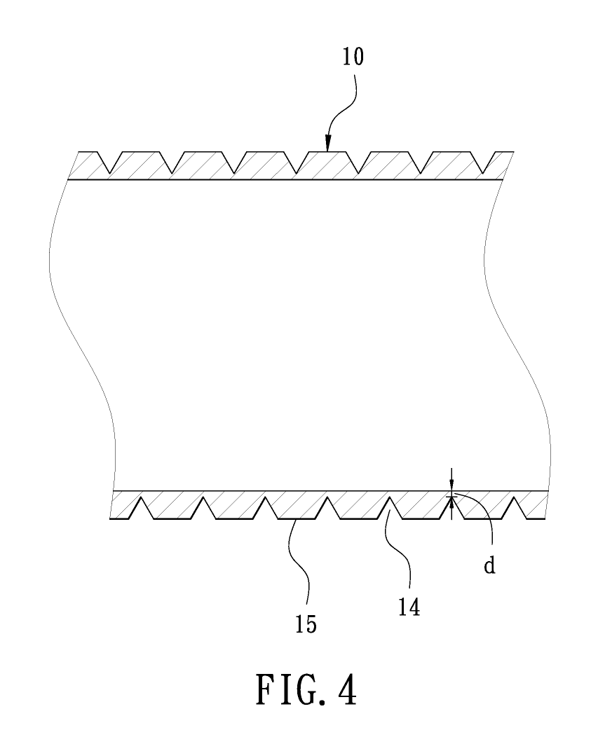

A preferred embodiment of the pre-bracing tube 100 of a cold shrinking sleeve in the present invention, as shown in FIG. 3, includes a tubular body 10 made integrally of plastic. The tubular body 10 has one end defined to be a main cable section 11 and another end to be a bifurcation connection section 12, and the main cable section 11 is formed with a comparatively small diameter while the bifurcation connection section is formed with a comparatively large diameter. A convergent portion 13 is formed between the main cable section 11 and the bifurcation connection section 12, and a convergent slant is formed at the location of the convergent portion 13, letting the convergent portion 13 of the tubular body 10 gradually contracted toward the main cable section 11. When being injection molded, the tubular body 10 has its outer circumferential wall formed with many tearing grooves 14 that are spirally and continuously arranged around the outer circumferential wall of the tubular body 10. The tearing grooves 14 are respectively a V-shaped groove by which the tubular body 10 is formed into a comparatively thin portion, as shown FIG. 4, and the thickness (d) of the tubular body 10 at the location of the tearing grooves 14 is 0.3 mm. A belt body 15 is formed between every two tearing grooves 14 of the tubular body 10 and equally, the belt bodies 15 are spirally and successively arranged around the outer circumferential wall of the tubular body 10.

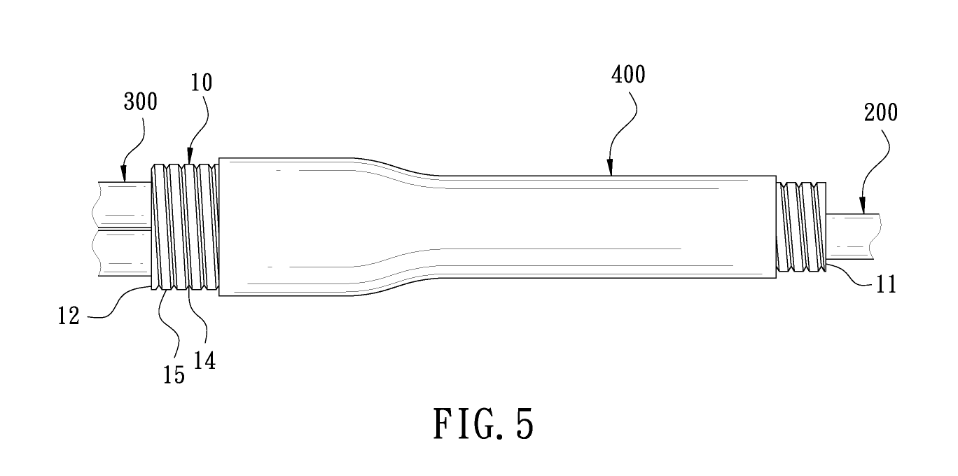

In using, referring to FIG. 5, the tubular body 10 has its outer circumferential side fitted thereon with a cold shrinking sleeve 400 and its interior received with a cable bifurcation joint. When a main cable 200 is to be bifurcated and connected through the cable bifurcation joint, the main cable 200 is first inserted through the main cable section 11 to let the tubular body 10 fitted and covered on the outer circumferential side of the cable bifurcation joint. Since the end diameter of the bifurcation connection section 12 is larger than that of the main cable section 11; therefore, the bifurcation connection section 12 is large enough for two ramified and connected cables 300 to be inserted therein to enable the tubular body 10 to be smoothly fitted and covered around the bifurcated and connected portions of the cable bifurcation joint on a cable circuit.

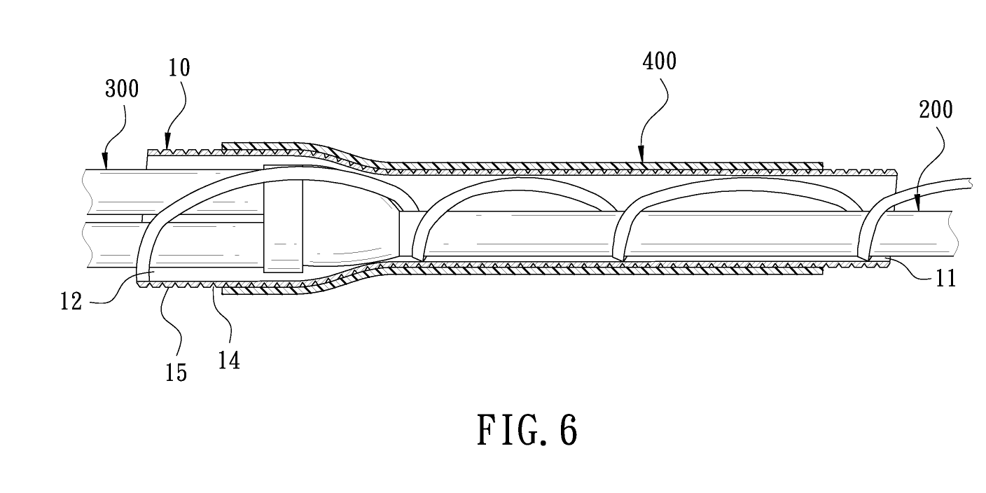

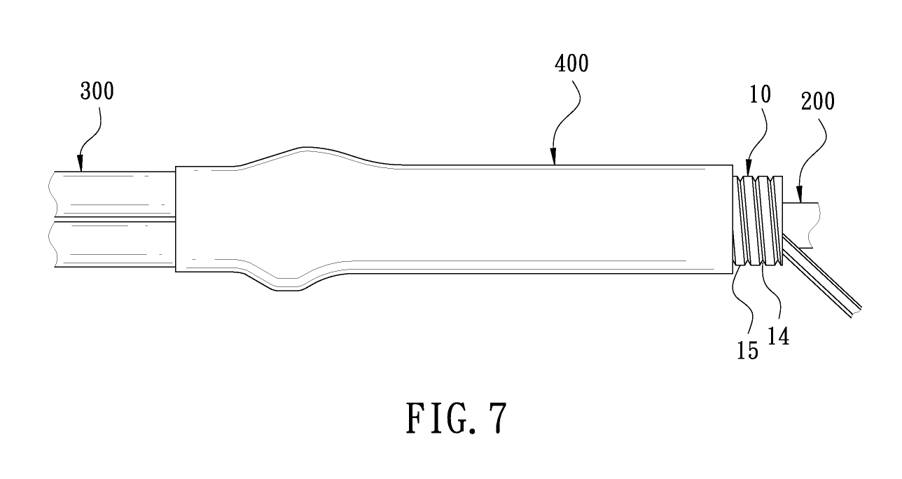

Referring to FIGS. 4, 6 and 7, when the tubular body 10 is torn along the tearing groove 14, the tubular body 10, being comparatively thin at the location of the tearing groove 14, will be easy to be torn and broken at the location of the tearing groove 14 and the broken state will be spread continuously along the tearing groove 14, letting the tubular body 10 torn and broken and form the belt body 15. At this time, a user can apply force to pull the belt bodies 15 for continuously ripping the tearing grooves 14 of the tubular body 10 and take advantage of an opportunity to have the belt bodies 15 removing the torn and broken portion from the tubular body 10. Since the tubular body 10 is broken along the tearing grooves 14, therefore, the cold shrinking sleeve 400 fitted on the outer circumferential side of the tubular body 10 will lose supporting force and shrink inward along the broken side of the tearing grooves 14 and further cover up the bifurcation and connection portion of the cable bifurcation joint on the cable circuit. At this time, a user only needs to draw away the belt body 15 and rip the tearing groove 14 continuously to have the tearing grooves 14 broken successively by the drawing force of the belt bodies 15 and thus, the broken portion can be drawn out of the tubular body 10 until the broken portion is completely removed from the tubular body 10.

The special features of this invention is that the tearing grooves 14 are respectively a V-shaped groove and form a comparatively thin portion of the tubular body 10, thus facilitating the tubular body 10 to be torn by force. In addition, the thickness (d) of each tearing groove 14 of the tubular body 10 is only 0.3 mm to enable the tearing grooves 14 to be torn and broken, and such a thickness is not too thin and impossible to affect the structural strength of the tubular body 10.

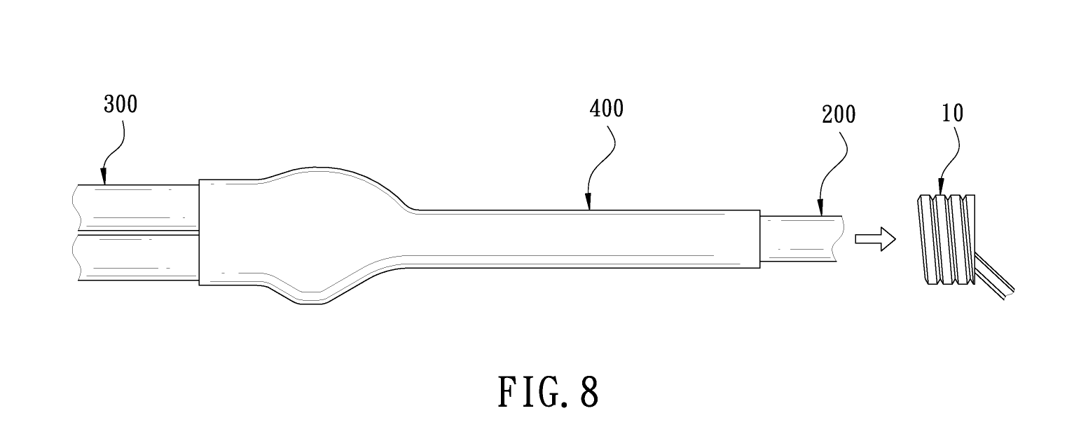

Referring to FIG. 8, when the tubular body 10 is torn along the tearing groove 14 and broken completely, the cold shrinking sleeve 400 can fully shrink and wrap the bifurcation and connection portion of the cable bifurcation joint on the cable circuit for protecting the cable bifurcation joint, able to avoid unstable construction quality caused by operation processes of winding and wrapping manually and increase the stability of construction quality in the wrapping and protection structure.

In addition, referring to FIG. 3, the tearing groove 14 of the tubular body 10 is formed when the tubular body 10 is injection molded, so it is needless to carry out any processing to the tubular body 10 for obtaining a finished product. Moreover, various molds can be made in the present invention according to practical needs to match with different diameters or lengths of pre-bracing tubes for manufacturing suitable pre-bracing tubes of cold shrinking sleeves, thus convenient in production, easy in manufacturing and able to lower cost and acquire economical gains.

While the preferred embodiment of the invention has been described above, it will be recognized and understood that various modifications may be made therein and the appended claims are intended to cover all such modifications that may fall within the spirit and scope of the invention.

What is claimed is:

1. A pre-bracing tube of a cold shrinking sleeve comprising a tubular body, said tubular body made integrally of plastic, said tubular body having an outer circumferential wall forming many tearing grooves when said tubular body is shaped, said tearing grooves spirally and continuously arranged around the outer circumferential wall of said tubular body, spiral and successive belt bodies formed between every two tearing grooves of said tubular body, said belt bodies taking advantage of an opportunity to have the torn portion drawn out of said tubular body when said tubular body is torn along said tearing grooves.

2. The pre-bracing tube of a cold shrinking sleeve as claimed in claim 1, wherein said tearing grooves are respectively a V-shaped groove.

3. The pre-bracing tube of a cold shrinking sleeve as claimed in claim 1, wherein a thickness of each said tearing groove of said tubular body is 0.3 mm.

4. The pre-bracing tube of a cold shrinking sleeve as claimed in claim 1, wherein said tubular body has one end defined to be a main cable section and another end defined to be a bifurcation connection section, said main cable section formed with a comparatively small diameter, said bifurcation connection section formed with a comparatively large diameter, said tubular body formed with a convergent portion between said main cable section and said bifurcation connection section, said convergent portion making said tubular body contracted gradually toward said main cable section.
